(19) United States
(12) Patent Application Publication
(10) Pub. No.: US 2013/0338970 A1
(43) Pub. Date: Dec. 19, 2013

(54) CRADLE TO GRAVE DESIGN AND MANAGEMENT OF SYSTEMS

(71) Applicant: Joseph P. Reghetti, Reno, NV (US)

(72) Inventor: Joseph P. Reghetti, Reno, NV (US)

(21) Appl. No.: 13/523,839

(22) Filed: Jun. 14, 2012

(51) Int. Cl. G06F 17/50

(52) U.S. Cl. CPC G06F 17/5004
USPC 703/1

(57) ABSTRACT

Described herein is cradle to grave design and management of a building. As one example, a computer aided design (CAD) program presents a “cradle to the grave” approach to the life cycle of a building. Smart objects are associated with attributes and maintained throughout the life cycle of a building. The attributes are used by a building information management system at various stages. Specific application may be found in nearly every component system of a building, including HVAC systems and power management systems.

### CROSS REFERENCE TO RELATED APPLICATIONS

This application is related by subject matter to U.S. patent application Ser. Nos. 12/150,791 and 12/150,867, both filed on May 1, 2008, which claim benefit under 35 U.S.C. §119(e) of provisional patent application Ser. Nos. 60/915,164 and 60/915,163, respectfully, both filed May 1, 2007, and 61/072,734, filed Apr. 2, 2008, the contents of which are incorporated herein by reference in their entirety.

This application is also related by subject matter to U.S. Pat. No. 8,150,660, filed May 1, 2008, titled “METHODS AND APPARATUSES FOR AUTOMATICALLY SELECTING A PIPE IN A CAD DRAWING”, the contents of which is incorporated herein by reference in their entirety.

### BACKGROUND

Computer Aided Design (CAD) programs are well known. The functionality of CAD programs may be limited. As one example, typical CAD programs tend to be focused on particular outputs or systems, such as, for example, the design of a building or trade contractor systems for a building, such as a sprinkler system, only. Once the building has been constructed from the designs, the drawings generated by the CAD programs, like paper blueprints, are filed away and never used again.

### SUMMARY

In an embodiment, a program is provided for cradle to grave design and management of systems. As one example, a CAD program presents a “cradle to the grave” approach to the design and management of a building. In such an example, the CAD program includes programming, code, software, algorithms, methods, systems and the like that facilitate the initial design of a building, automobile, airplane, locomotive, electrical power generation and distribution systems, gas and water production and distribution systems, sewage systems or any other type of object or system, including all structural elements, such as, in the case of a building, the foundation, the windows, supports, walls, ceilings, floors, and the like. The CAD program can facilitate the addition of other component systems such as mechanical systems, elevators, sprinkler systems, HVAC, plumbing, wiring, cabling, alarms, communications, lighting, computing and building management systems, building information management (BIM), smart components, monitors, sensors, and the like. The program can also allow for the input of geographic features, regional features, weather, temperature, seasonal changes, and other geographic factors which may be of interest in the management and life cycle of a building. The program can also include rendering in two or three dimensions, simulation, conflict resolution, virtual tours, various display modules, construction and commissioning. As the building is blueprinted and constructed, changes can be input to the design. Real operating conditions can then be input to the program, and the building may be simulated, monitored, managed, optimized, and verified in real time or near real time during actual operation.

The cradle to grave design and management of a system may include specifications for aspects of system management, such as, for example, a required temperature range, energy transmission information, or a set of safety protocols. These specifications can influence the design and management of a system. As the system is designed, specifications can be used to resolve conflicts and allocate resources.

The design and rendering in both two and three dimensions are provided for. Simulation of every element is also provided for. Virtual tours are provided for. As the design is further developed, blueprints can be created and updates to the design can be made as changes in the actual construction take place. As such, even after a building is constructed, the program may be used in conjunction with the current state of a system to simulate responses and update the usage of component systems of a building.

After the construction of, for example, a building, the CAD program may allow for updates, including the full design and implementation of the building, including all components. Real time, near real time, and/or historical information from networks, sensors, and the like can be used in conjunction with the design in the CAD program. Simulations, optimizations, updates, and other changes can be made in response to the information as modeled/processed and/or input in the CAD program. This framework for the operation of the building and may be used in conjunction with building information management (“BIM”) and sensors to continuously monitor, maintain, run simulations on, improve the operations of, update, verify, and optimize the building operations.

In an embodiment, each element, including for example, structural elements, component systems and geographic features of a design may be an object or smart object. Each object may be associated with a series of attributes. These attributes for each object may include knowing the type of object, the specifications (such as connections, power, thermal, etc.) of the object, the connections and communication capabilities of the object, BIM data, or attributes associated with BIM. In one embodiment, this information is used in the design and management of a building.

As one example of the above, the CAD program includes all structural, internal, and geographic elements. An HVAC system may include information related to the output of airflow from one or more vents. In turn, this information may be used in context with the other aspects of the building to simulate, as one non limiting example, temperature in a portion of the building. Further to the above, this temperature may also take into account seasonal factors, the angle of the sun, the geography, nearby windows and the like. Further still, sensors may be incorporated into the simulation, thereby providing a point of feedback to for the simulation, and later in the building life cycle, real feedback which can then be used as an aspect of BIM to optimize one or more aspects of building management.

As an additional example of a system above, a smart power grid system may be designed and managed, where all components, geographic factors, structural/building elements and the like may be included. Output requirements, profiles and the like may be associated with specifications for a power grid. Accordingly, the design can be relied upon to influence the efficiency of the final systems and the final system can be optimized by updating the design and incorporating the design with real time or near real time data for optimization and management.

### BRIEF DESCRIPTION OF THE DRAWINGS

FIG. 1 depicts a block diagram for a cradle to grave design and management of a building.

FIG. 2 illustrates a block diagram of an example information flow and/or simulation of cradle to grave design and management of a building.

FIG. 3 illustrates a block diagram for combining multiple elements of the design of a facility into a design choice loop.

FIG. 4 illustrates a block diagram for combining multiple elements of the design of a facility and the implementation and monitoring of a facility in facilities management.

FIG. 5 illustrates a flow chart for assigning objects attributes and using the objects in building design.

FIG. 6 depicts a flow chart for the design and management of an HVAC system.

FIG. 7 depicts a flow chart for the design and management of a smart grid.

### DETAILED DESCRIPTION OF ILLUSTRATIVE EMBODIMENTS

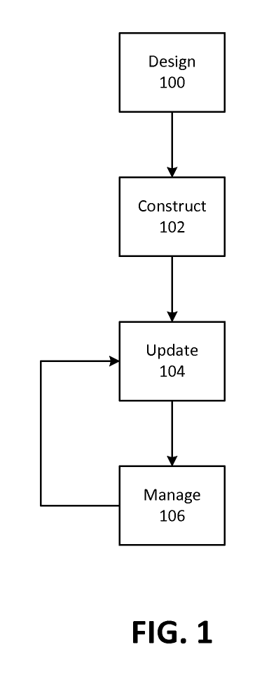

FIG. 1 depicts a block diagram for a cradle to grave design and management of a building. In an embodiment, the design of a building is provided for at 100. The design of a building may include a great number of sub-steps in various contexts. For example, a building design may begin with the input of geographical elements, local regulations, safety information, size, and other specifications. This geographic information may comprise one or more libraries and/or databases coupled to a program. The geographic information may be input by a user or received from a network, database or the like. As one set of examples, the geographic information may comprise information related to the season, weather, building codes, temperatures, earthquakes, flood plains, soil/bedrock, usage, foundations, wind, pollution and the like.

In addition to the above, design specifications may be included for operational information. In an embodiment, operation information may comprise water consumption, gas consumption, alarm systems, waste management, sewage, pumps, elevators, wiring, electronics, computing, building information management (BIM), communications, telephones, internet, wireless signals, speakers, gates, locks, access cards, power specifications, backup power specifications, sprinklers, heating, cooling, lighting, airflow, alarms, building codes, component types, sensors, shutters, and/or any other type of specification. These specifications may vary with time, on an hourly, daily, weekly, monthly, seasonal, yearly or any other time basis. In addition, although the term “specifications” is used, it is understood that the specifications may be goals, general descriptions, targets, maximums, minimums, averages, rates, variability, specifications, and the like. As one non limiting example, a specification may include a target value of zero energy consumption. As an additional example, a specification may include a profile of the maximum energy consumption throughout a given day. The profile can vary with time. These component specifications may be input by a user, received from a library, received via a network or otherwise input into the design 100.

Further to the above, design 100 may comprise building specifications for the building. As one set of examples, this may include specifications for cost, height, size, materials, populations/usage, beams, columns, construction times, modularity, insulation, ventilation, concrete, manufacturers, tolerances, doors, windows, glass type or any other building specifications. These building specifications may be input by a user, received from a library, received via a network or otherwise input into the design 100.

The geographic, component, and building specifications may comprise general specifications for the facility. In addition, the design of a building may comprise individual specifications for, as one example, component systems and/or for components themselves. As such, there may be a specification for overall energy consumption, and a specification for the energy consumption of the HVAC system. The specification for the HVAC system may be divided up as specifications for the heater and chiller, specification for the vents, sun lights, window shades, and the like. As such, specifications may be allocated among systems and components and these specifications may be used to drive the design 100.

In an embodiment, the design 100 may comprise software that a user may input information related to specifications in a building. Design 100 may also receive specifications form any other location, including a network, library, database etc. In addition, the specifications as provided in design 100 may be changed at any time with regard to the other updates.

Each of the geographic specifications, the component specifications and the building specifications may be configured as smart objects. As one example, a smart object may be associated with additional information. The additional information may be contained in one or more layers and/or file structures associated with the specification and/or associated with the smart object. This information may be derived from any source, including a network, library, or user input. Each object may comprise an interface for inputting information related to the smart object.

The additional information of a smart object may comprise, as a set of non-limiting examples, information used to configure the specification in one or more contexts. Further, the smart objects may have information used to drive the design 100. For example, a component may comprise component specifications. As one example, the component may require a set of one or more hook ups in the form of pipes, air flow, communications, wiring, heating, water etc. As such, the design 100 may be influenced by smart objects that contain additional information about necessary elements for the operation of the object.

Further to the above, smart objects may comprise additional information that may be used in other contexts, such as the modeling of a building in one or more ways. For example modeling in 2-D may require each specification be hidden, or that one or more specifications is displayed in one or more ways. The same may be true for 3-D modeling, virtual tours, management of the building, construction, optimizing, verifying, simulating, or system modeling (such as HVAC modeling, wiring modeling, sprinkler modeling, alarm system modeling, water modeling, temperature modeling, and the like). As such, for each of the various contexts, aspects of the smart object may be express or hidden depending on the context.

As another example of use in context, energy consumption of a facility may be one of the specifications. The design 100 is used to create virtual tours, draft 2-D and 3-D models, simulate components and components systems, model structures, internal elements, and geographic elements of a facility, determine the energy usage based on the structure, internal elements, and geographic elements. Updates may then be made or suggested to the extent that the design may need to improve to meet and/or exceed the energy specification.

In one embodiment, a CAD program may comprise one or more software layers. One or more of the software layers may comprise specifications of design 100. As one example, layering the software may facilitate improved program operation, design rendering and the like. Further to this, the specifications may be associated with any object in a program as an attribute.

In an embodiment, design 100 allows for the selection of specific items, components, systems, elements, beams, columns, floors, ceilings, windows, doors, electronics, computers, heaters, chillers, vents, lights, glasses, shutters, blinds, gates, wires, pipes, gauges, elevators, fittings, fixtures, walls, foundations, appliances, office equipment, furniture, escalators, generators, roofing, stairs, ramps, studs, insulation sensors, cameras, monitors and the like. Each of these items may be smart objects and may be associated with attributes. As noted above, the attributes may be received from any source, including commercially available products, via a network, library, database or user interface. The attributes may comprise BIM, source, cost, material, color, thermal data, strength data, consumption data, life cycle information, performance, weight, dimensions, density and the like. These items may also have information related to their requirements in various contexts as described above with respect to the specification contexts.

Sensors, monitors, cameras and the like may be used to monitor one or more loads as noted above, which can include temperature, humidity, airflow, lighting, electrical consumption, liquid flow, number of people and the like. Sensors may be included in a library of commercially available components. The sensors may be modified by the end user or third parties to allow for the addition of new components with their design and performance attributes.

Each sensor in a design may be associated with design and performance attributes. The attributes may define the energy consumption, ratings, sensor type, quality, performance, weight, material, cost, mass, emissions, life spans, heat emissions or any other attribute. One or more attributes may be included in BIM and/or BIM data.

In an embodiment, adding one or more of a mechanical, structural, electrical, or smart component may be associated with specifications for including those components in the facility. For example, any mechanical component may also be associated with wiring, communications, vents, connections, cables or any other component. As such, adding a component to a design may create conflicts or otherwise affect the projection of other mechanical, electrical, structural, or smart components in a design. The program may alert a user to these conflicts and/or suggest solutions.

Each of the above components may also be associated with motion vectors, moving parts, ranges of motion, tolerances and the like. In an embodiment, the range of motion may be constrained by other elements of a building or a limitation based upon the component itself. As such, conflicts from moving elements may be found and eliminated.

Attributes of the components may be associated with the component, although one or more software layers and/or file structures may be associated with the components to improve the execution of the program. Each component can be an object and can be associated with attributes. One or more of the attributes may be included in BIM and/or BIM data.

Each component in a building may be associated with attributes. Attributes can include cost, energy specifications, materials, manufacturer, range of motion, age, lifespan, type, connectors, dimensions, replacement information, output, flow, pressure, density, capabilities, tensile strength, elasticity, brittleness, and the like. In an embodiment, these attributes may be associated with building information management (BIM) and may comprise BIM data. As one example, when a component is modeled, the component may be displayed as a portion of a drawing. The component may also be associated with one or more layers of data and/or file structures that are configure to contain information related to one or more attributes of the component. Further to this, the layers may be populated with data either by a user or from one or more libraries associated with the component. The structure of the component with layers and associated attributes may improve the speed of simulation, rendering, modeling, data manipulation, and the like.

In one embodiment, this may comprise assigning a starting location and providing a first person view of the three dimensional model. Design 100 may be configured to allow a user to navigate through a model of a facility using one or more user inputs. The user may be able to select which components/systems/specifications of the model are visible, including attributes in one or more labels configured as, as one non-limiting example, labels on components.

As another example, virtual tours may be associated with building operation during simulation. For example, a tour of the heating system during a cold snap may be simulated and a virtual tour of the responses can be displayed. Tours of simulated situations may include energy loads, temperature, rate of change of temperature, earthquakes, wind, rain, snow, and the like.

In an embodiment, design 100 may provide for modeling the various components in context. As one example, one or more of the several components of a building can be affected by geographic factors. The geographic factors will affect the components based in part on the attributes of the component. Collectively, the components and geographic factors make us a system for which multiple options are available for managing a building in context. Multiple possibilities for addressing geographic factors in accordance with the specifications of design 100 may be modeled individually or in combination in order to determine one or more solutions that align with the specifications of design 100.

As one non limiting example, a portion of a facility may be near both a window and a vent. The portion of the building can be too hot. In this example, the window may be either shuttered to decrease sunlight or an increase in cool air may be sent to the area via the vent. Geographic features such as the angle of the sun, structural features such as thermal properties and the size of the space, component features such as thermal output and thermal properties can be considered in simulation. Thus, the effectiveness of each course of action may be determined in combination with the energy specifications and/or the effect of changes on the building. As such, in response to a geographic factor, various solutions may be provided.

In another embodiment, design 100, computer aided simulation may be used after building construction 102 and in combination with update 104 and management 106. In such an embodiment, the three dimensional model may include the design 100 and be updated 104 with any changes that took place during the actual building construction 102. As such, an accurate model of the facility is maintained. Further, actual real-time, near real-time and/or historical geographic information from sensors and smart systems may be fed into the model. Based on the real information, simulations may be run to determine solutions to problems that are in accordance with specifications.

In an embodiment, information related to the simulation the design 100 can be associated with one or more software layers and/or file structures that can improve the execution of the program.

Cradle to grave building design and management may also comprise construction 102. In one embodiment, during construction 102, blueprints may be made and the design 100 may be updated 104 with the actual elements of the construction 102. Each specification, components, element, object, attribute and the like may be associated with data that are configured for construction 102. As one example, they may be configured for representation on a set of one or more blueprints in one or more ways depending on the aspect of the building under construction.

Updating 104 may take place during construction, or it may take place in connection with management 106. As components are switched during management or construction, updates 104 may take place. Remodels to the building could be handled in a similar way, with design 100 and construction 102 feeding into updates 104 and management 106. These may be input into the cradle to grave management of a building. As such, the program may comprise a running record of all of the elements, specifications, components, features and the like of a building.

Update 104 may also comprise updates in the form of information from one or more smart objects or sensors. These smart objects or sensors may provide real time, near real time, or historical information about the status of a building. As such, the building may be managed based on real information. In one embodiment, this information may be used in any context, including but not limited to, simulating the environment, optimizing the environment according to the specifications, monitoring aspects of the building, controlling the operation of various components and systems, powering up, powering down systems, replacing worn or dated components, ensuring safety and comfort, controlling the response to external factors or disasters, backup operations, software updates, alarms, safety and the like.

Management 106 has features of a building control system embedded in it, including the ability to control any of the installed equipment that can be remotely controlled (security, HVAC, lighting, signage, shutters, doors, PLC, relays, modules, controllers, current, voltage, etc.)

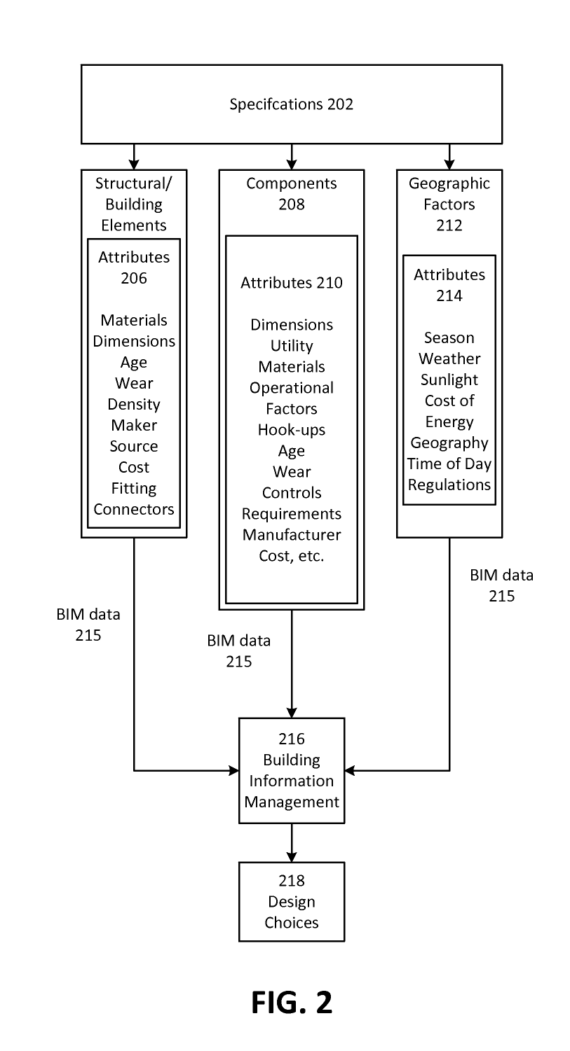

FIG. 2 depicts a flow chart for the cradle to grave design and management of a building. As depicted in FIG. 1, specifications 202 can be used in conjunction with a CAD program. In one embodiment, the specifications 202 may be input by a user at any point during the use of a CAD program. In another embodiment, specifications 202 may be derived from or modified by one or more structural elements 204, components systems 208 and/or geographic factors 212.

As an example of the above, a building can be associated with a geographic factor, such as being located in a fault zone. In such an embodiment, there may be regulations/specifications associated with the fault zone. As such, these specifications may be included in a library in the CAD program, they may be imported from an external source, and/or they may be input/altered by a user.

Although specifications 202 are used above in a general sense, it is understood that specifications 202 may be divided up, partitioned, grouped, collected, or manipulated in any way. For example, there may be an overall specification for energy consumption. There may also be an HVAC energy consumption specification, a lighting energy specification, etc. The system component specifications may total the overall specification or otherwise may be associated with one or more additional specifications.

As noted above with regard to FIG. 1, the specifications 202 may include goals, general descriptions, targets, maximums, minimums, averages, rates, variability, specifications, and the like. The specifications 202 may include specifications for energy performance, energy ratings, energy consumption profiles, peak energy demand, load profile, load factor, specifications for the building management system, water consumption profiles, peak water demand, gas consumption profiles, peak gas demand, heating, cooling, lighting, component types, safety specifications, and/or any other type of specification. These specifications 202 may change with user preference, changes in components, the time of day, season, age of the building, changes in regulations and the like.

The specifications 202 may be contained in one or more layers or file structures. The information related to specifications 202 may be contained in one or more memories associated with a processor. In one embodiment, a CAD program may have one or more functionalities related to rendering, touring, simulating, 2-D modeling, 3-D modeling, optimizing, printing, commissioning, managing, and verifying a building. Each functionality may be associated with features, which can include displays, interactive elements, menus, tools, icons, sliders, keys, instruction sets, pages, layers, settings, preferences, defaults, etc. In certain functionalities, one or more layers of information may be hidden, while in other functionalities, one or more layers may be expressed in one or more ways. Doing so can improve the execution of the program.

FIG. 2 depicts structural elements 204. As noted above with respect to FIG. 1, the structural elements 204 may comprise walls, windows, ceilings, columns, floors, supports, beams, studs, foundations, doors, etc. The structural elements 204 can be called from a library of structural elements or input from other sources and can have a set of associated structural element attributes 206. The structural element attributes may be input by a user or they may be associated with the structural element 204 in the library or other source, such as a manufacturer or distributor. In an embodiment, the structural elements 204 can be contained in a first set of one or more layers or file structures and structural element attributes 206 can be contained in a second set of one or more layers or file structures. As such, structural elements 204 may be smart objects. Structural elements 204 as smart objects may comprise any number of structural element attributes 206. In one embodiment, each structural element 204 may be selected and one or more structural element attributes 206 may be displayed to a user. Further, these smart objects may have associated fittings, connectors, hook-ups and the like. As a building is designed, design choices 218 may be influenced by the structural elements 204 selected.

FIG. 2 also depicts components 208, which may be part of component systems described above with respect to FIG. 1. Components 208 may include components for any system including electrical, HVAC, plumbing, sprinkler, wiring, communications, alarms, sensors, cameras, security, safety, elevator, mechanical, pumps, vents, shutters, blinds, etc. The components 208 can be called from a library of components and can have a set of associated component attributes 210. The component attributes may be input by a user or they may be associated with the components in the library. In an embodiment, the components 208 are smart objects. Smart objects may comprise any number of component attributes 210. In one embodiment, each component 208 may be selected and one or more component attributes 210 may be displayed to a user. Further, these smart object may have associated fitting, connectors, hook-ups and the like. As a building is designed, design choices 218 may be influenced by the components 208 selected.

FIG. 2 also depicts geographic factors 212. As noted above with respect to FIG. 1, the geographic factors 212 may comprise regulations, weather, wind, soil, geography, temperature, location etc. The geographic factors 212 can be called from a library of geographic factors and can have a set of associated geographic factors 214. The geographic factor attributes 214 may be input by a user or they may be associated with the geographic factor 212 in the library. In an embodiment, the geographic factors 212 can be contained in a first set of one or more layers or file structures and geographic factor attributes 214 can be contained in a second set of one or more layers or file structures. As such, geographic factors 212 can be smart objects. Geographic factors 212 as smart objects may comprise any number of geographic factor attributes 214. In one embodiment, each geographic factor 212 may be selected and one or more structural element attributes 214 may be displayed to a user. Further, these smart objects may have associated specifications. As a building is designed, design choices 218 may be influenced by the geographic factors 212.

FIG. 2 depicts building information management 216. In one embodiment, building information management (BIM) 216 can comprise BIM data. BIM data can be data that is entered and stored with a smart objects' attributes. For example, structural element attributes 204 may comprise BIM data. Component attributes 210 may comprise BIM data 215, and geographic factors attributes 214 may comprise BIM data 215. Further, each attributed noted above with respect to structural elements, components, and/or geographic factors may be included in BIM data 215. As such, BIM data 215 may comprise one or more of materials, cost, manufacturer, dimensions, age wear, density, source, utility, operational factors, hook ups, connectors, controls, specifications, seasons, weather, wind, sunlight, geography, regulations, range of motion, torque, pressure, weight, safety, energy usage, temperature, flow, cost of energy, fittings, time, etc. for every object in a design.

In one embodiment, BIM data 215 may be associated with an object. The BIM data may be selected and displayed to a user. As one example, activating a particular functionality of a CAD program may highlight or display one or more types of BIM data. As another example, BIM data can be stored, selected, modified, or used in any manner.

In an embodiment, BIM data 215 is used in each of the design, simulation, commission, construction, 2-D display, 3-D display, rendering, management, verification and optimization. As one example, building information management 216 utilizes BIM data 215. In such an example, the BIM 216 may be used to perform one or more functions, such as ensuring that the design satisfies specifications 202 with a given set of structural elements 204, components 208, and geographic factors 212. Other functions include resolving conflicts between structural elements 204, components 208, and geographic factors 212, such as conflicts in space, energy consumption, fittings, communications, range of motion, operating temperature, replacement, etc.

In another embodiment, BIM data 215 is used by BIM 216 to direct a user to particular elements in structural or component libraries to avoid future conflicts. As one example, BIM 216 may limit library choices such that pipe fittings are limited only to those of the same specification.

As such, BIM data 215 and BIM 216 can influence design choices 218 as depicted in FIG. 2.

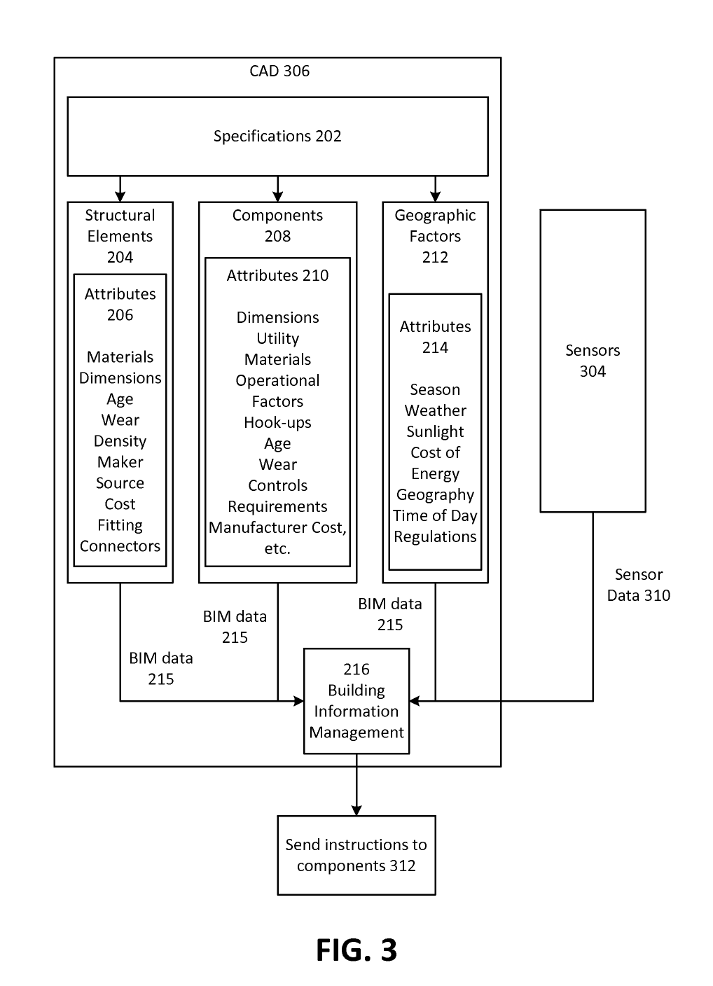

FIG. 3 depicts a flow chart for the cradle to grave design and management of a building. Similar to FIG. 2 above, FIG. 3 comprises specifications 202, structural elements 204, structural element attributes 206, components 208, component attributes 210, geographic factors 212, geographic factor attributes 214, BIM data 215, and BIM 216. FIG. 3 further comprises CAD 306. CAD 306 may comprise a computer readable medium having stored thereon instructions that when executed on a processor cause a processor to perform various functions, steps, algorithms, processes and the like. Further CAD 306 may be stored on non transitory, non transient, or computer readable storage media. As used herein computer readable storage media may comprise any disk or drive configured for the storage of machine readable information and may include floppy disks, CDs, DVDs, optical storage, magnetic drives, solid state drives, hard drives, or any other memory device known in the art.

CAD 306 may be a program in which a building may be designed, further, this software may receive and send information to and from components of a building such as sensors 304 and components 308.

In one embodiment, information from sensors 304, which may be incorporated throughout a building to provide sensor information, which can be real-time, near real time or historical information related to structural elements 204, components 208, and/or geographic factors 212. Sensor data is sent to CAD program 306. Accordingly, CAD program 306 may be able to use the information in one or more ways to simulate, verify, and/or optimize the building operations. For example, the sensor data 310 can be input into the 2-D, or 3-D model. Further the sensor data 310 and the BIM data 215 may be used in one or more algorithms, process, programs and the like. Simulations replicating the current state of the building can be run. Specifications, user input, geographic information, sensor data 310, BIM information 315, and the like may indicate a need to make one or more changes to the state of the building. Further simulations may be run to determine one or more courses of actions. Those actions can be optimized and instructions can be sent to one or more components of the building to enact the changes by sending instructions to components 312.

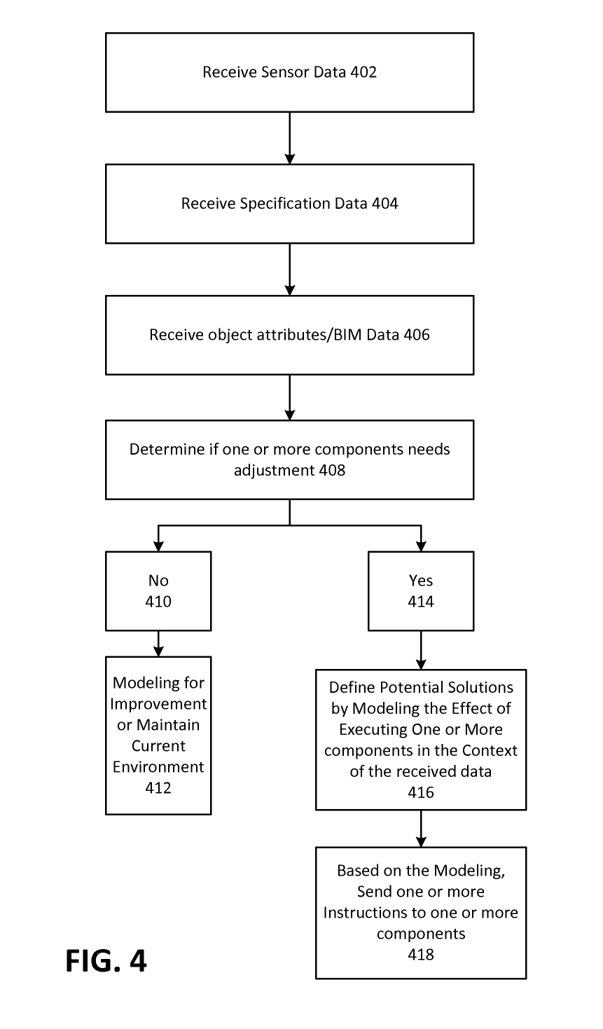

FIG. 4 depicts an example method for receiving sensor data such as sensor data 310 noted above and using the sensor information with specifications, BIM, structural, component, and geographic information to design, manage, construct, simulate, model, etc., building operations.

At 402, sensor data may be received. In one embodiment, this data may be received by an element of a CAD program and be configured for use in BIM. As another example, sensor data may be received by one or more computing devices which may configure and/or send the information to CAD program. This data may comprise real-time, near real-time and/or historical data. In one embodiment, step 402 may comprise means for receiving sensor data.

At 404, specifications data may be received. As noted above, specifications data may comprise data related to specifications 202 or the specifications from design 100. The specifications data may be received by the BIM systems and may be used in one or more ways with other data to simulate, commission, manage, optimize and verify any aspects of a structural element, component, geographic factor or any combination thereof of a building. In another embodiment, step 404 may comprise means for receiving specifications data.

At step 406 object attributes and/or BIM data may be received. As noted above, object attributes and/or BIM data may comprise structural element attributes 206, component attributes 210, geographic factor attributes 214 and/or BIM data 215. The object attributes and/or BIM data may be used in one or more ways with other data to simulate, commission, manage, optimize, and/or verify any aspect of a structural element, component, geographic factor or any combination thereof in a building. In another embodiment, step 406 may comprise means for receiving object attributes/BIM data.

At step 408 a determination is made if one or more components needs an adjustment. In an embodiment, one or more processors executing one or more programs may make this determination based on the data received at steps 402, 404, and 406. This determination may be made in one or more contexts of a CAD program. Although the term “needs” is used, it is understood that the determination could be made that a change is optimal, advisable, required, suggested or the like. In one embodiment, step 408 comprises means for determining if one or more components need adjustment.

At step 410, the determination of step 408 may be that no change needs to be made. In one embodiment, this may be because the sensor data is in accordance with the specifications data. In another embodiment, the determination could be made based on one or more user inputs (not shown). Further still, the determination could be made because there are other actions/specifications and the like that have a higher priority. In one embodiment, step 410 may comprise means for a ‘no’ determination.

At step 412, based on a no determination, there may be a modeling for improvement and/or the current environment may be maintained. As one example, the specifications for energy and the like may be met and the temperature of the building may be within an appropriate range. Accordingly, the systems may not need to switch, however, optimization algorithms based on the received data may determine that there is a more efficient way to manage one or more components. In such an example, instructions may be sent to one or more components to optimize the components of a building. In another embodiment, step 412 may comprise means for optimizing and/or maintaining the environment of a building.

At step 414, it may be determined that adjustments are needed based on the determination in step 408. In one embodiment, this may be because sensor data is not in accordance with the specifications. In another embodiment, this may be because of some sudden change in the geographic factors, such as a fire, an alarm sounding, an earthquake, the entry of a large number of individuals into a building, a malfunction of a piece of monitored equipment, a user input or any other factor. In one embodiment, step 414 may comprise means for a ‘yes’ determination.

At step 416, potential solutions may be defined by modeling the effect of executing one or more internal components in the context of the received specifications data 404, the received sensor data 402, and/or the received object attributes/BIM data 406. As one example, the data may be used to determine which specifications are not met and how best to meet them by using one or more components in conjunction. Accordingly, component usage may be simulated, managed, verified and optimized to determine one or more potential solutions to satisfy the specifications based on the sensor data. In an embodiment step 416 may comprise means for defining potential solutions by modeling the effect of one or more components in the context of the received data.

At step 418, instructions may be sent to the one or more components based on the modeling of step 416. As one example, the may comprise sending data to other processors which control the operation of one or more components. In another embodiment, step 418 may comprise means for sending one or more instruction to one or more components based on the modeling from step 416. It may also mean sending one or more instruction to a monitoring station component that is connected to the CAD program 306 so an operator can be warned or alerted to take some action, or to log the information, etc.

Although FIG. 4 depicts a series of steps, it is to be understood that these steps/means may take place in any order, and exclude any individual step/mean while including any other step or means.

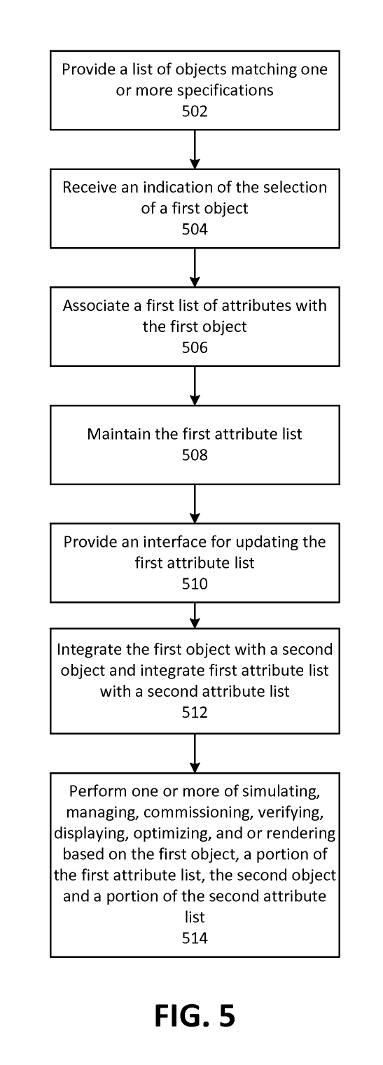

FIG. 5 depicts a flow chart for associating attributes with objects, integrating objects and attributes and performing one or more of design and management of a building based on the objects and attributes.

At step 502, a list of objects matching one or more specifications may be provided. In one embodiment, the specifications may be the specifications 202 associated with design 100 of FIG. 1 above. The list of objects may be the libraries of structural elements, components and component systems and/or geographic factors described above. These lists may be from libraries may be of commercially available elements. The list may be provided in software for user selection. Step 502 may comprise means for providing a list of objects matching one or more specifications.

At step 504, an indication of the selection of a first object may be received. As one example, a computing device may be configured to receive an indication that a user has selected a first object. Step 504 may comprise means for receiving an indication that a first object has been selected.

At step 506, a first attribute list may be associated with the first object. In one embodiment, the first attribute list may be associated with the first object in the library and these attributes may be maintained with the first object 508. In another embodiment, upon selection of the first object, the first attribute list may be displayed and may be unpopulated, partially populated or fully populated. As such, the first attribute list may be associated with an interface for updating the first attribute list 510. In one embodiment, step 506 may comprise means for associating a first list of attributes with the first object, step 508 may comprise means for maintaining the first attribute list, and step 510 may comprise means for providing an interface for updating the first attribute list.

At step 512, the first object may be integrated with a second object and the first attribute list may be integrated with a second attribute list. It is understood that only certain objects and certain object attribute lists will interface properly. As such, during the design of a building, selection of certain objects may limit later design decisions. Further still, certain objects may be associated with a fixed set of additional objects that must be included in a design based on the use of the first object. In one embodiment, the attributes associated with integration with other objects and with required additional objects may be maintained in one or more attribute lists. In another embodiment, position, orientation, connections, supports, wires, pipes, hook-ups etc. may all be associated with either an object or an object attribute list. These attributes may be used in interfacing two or more objects. Accordingly the design choices of step 512 may be related with the selection of previous objects. In another embodiment, step 512 may comprise means for integrating a first object with a second object and means for integrating a first attribute list with a second attribute list.

At step 514, one or more cradle to grave design and management of a building actions may be performed based on the first object, a portion of the first attribute list, the second object and a portion of the second attribute list. A portion may comprise any portion, including all, none or any amount in between of the attribute list. The various functions may be performed in different software modules and may take advantage of different attributes. Attributes lists may be contained in one or more software layers or file structures. As such, during modeling, certain attributes may be used while others are not. By separating data into layers and file structures, execution of the program may be made more efficient. Step 514 may also comprise means for performing one or more actions, such as simulating, managing, commissioning, verifying, displaying, optimizing, and or rendering of a design may be performed based on the first object, a portion of the first attribute list, the second object and a portion the second attribute list.

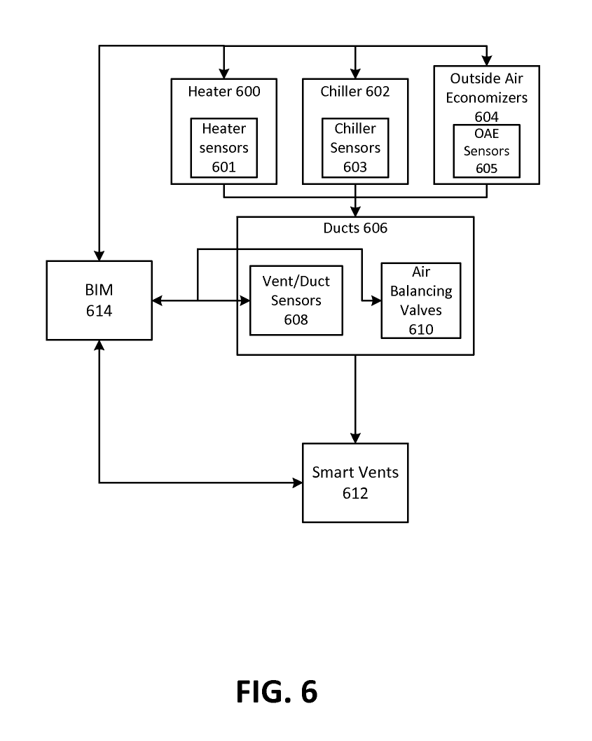

FIG. 6 depicts an exemplary embodiment involving an HVAC system including various components for the management of an HVAC system. It is to be understood that although the information herein is directed towards HVAC, other component systems found in a building may be managed in similar ways and that the design of a building may include information, components and sensors sufficient to manage a building according the following description.

At 600, an HVAC system may comprise a heater 600, which, as shown in the figure may comprise heater sensors 601. In current management and operation of a building, there are instances when a heater 600 may be on at the same time as a chiller 602, which may involve a tremendous waste of resources. Regardless, the heater sensors 601 associated with heater 600 may comprise one or more sensors configured to determine one or more of the energy consumption, the state, the requirements, controller configurations, maintenance needs, turn on times, turn off times, BTU output, and/or any other information associated with the heater.

An HVAC system may also comprise a chiller 602, which can be associated with chiller sensors 603. The chiller sensors 603 may comprise one or more sensors configured to determine one or more of the energy consumption, the state, the requirements, controller configurations, maintenance needs, turn on times, turn off times, BTU output, and/or any other information associated with the chiller.

An HVAC system may also comprise outside air economizers 604, which may be used in conjunction with one or more of the heater 600 and the chiller 602. The outside air economizers 604 may be associated with outside air economizers (OAE) 605. The OAE sensors may comprise one or more sensors configured to determine one or more of the energy consumption, the state, the requirements, controller configurations, maintenance needs, turn on times, turn off times, BTU output, and/or any other information associated with the outside air economizers.

In an embodiment, one or more of the heater, chiller, and outside air economizers may send and receive data from the BIM 614, which in turn may be associated with the CAD 306. As one example, the sensor data 601, 603, and 605 may be sent to the BIM 614 or CAD 306. The BIM or CAD may determine one or more courses of action based wholly or in part on the information from the sensors and may send instructions to one or more of the heater 600, the chiller 602, and the outside air economizers 604. As such, real time, near real time or historical data may be used in conjunction with a building model in BIM 614 and/or CAD 306.

An HVAC system may also comprise ducts 606, which may be used as a transport mechanism to control the temperature and/or airflow in a building. The ducts 606 may be associated with vents, pipes, valves and the like. The ducts may comprise vent/duct sensors 608 which can be placed strategically throughout the ducts and the building in general to determine the state of a building and otherwise manage the various components of a building associated with an HVAC system. As one example, the vent/duct sensors may determine the ambient temperature, the rate of air flow, and/or any other factors associated with HVAC usage and management. This information may be real time, near real time or historical and may be sent to BIM 614/CAD 306. As such, BIM 614/CAD 306 may incorporate the information from the ducts 606, the building design, and the sensors 601, 603, and 605 to determine one or more courses of actions for the HVAC system and may send instructions to air balancing valves 610, vents 612, ducts 606, heaters 600, chillers 602, and or outside air economizers 604 to manage, control, optimize, and verify the building.

An HVAC system may also comprise air balancing valves 610. As one example, these may comprise components in ducts that can be managed by one or more systems, including, for example, a BIM 614/CAD 306 system. The ducts 606 and air balancing valves 610 may be used to control the flow of air and the temperature of one or more regions in a building. As such, a first portion of a building may receive additional cooler/warmer air while a second portion may not.

An HVAC system may also comprise smart vents 612, which may be smart in that they can open and close, contain information related to the type of vent, the attributes, the requirements, connections, specifications, capabilities and the like. In one embodiment, the smart vents 612 may also comprise sensors. The vents may be controlled, operated, adjusted and the like by one or more management components, including, as one example, BIM 614/CAD 306. As such, building HVAC may be controlled in a granular fashion based on real time data and a building model operated by BIM 614/CAD 306.

BIM 614/CAD 306 may comprise a user interface wherein a user may be able to obtain information related to an HVAC systems and see a representation of one or more portions of a building. An adjustment may be made by BIM/CAD or input by a user and the model may display the timing and effects of such an adjustment. Further, each component used in the adjustment may be displayed and can be configured on an individual basis to improve the control and the granularity of control of an HVAC system in a building. For example, a building operator may desire to adjust the temperature setting in a portion of a building. The CAD 306 could be viewed to determine whether all of the relevant HVAC equipment is located for that portion of the building and a simulation could be run to determine present conditions, including simulations of air flow, velocity, temperatures and other factors. Based on that information, instructions could be input to the CAD 306 that would then be relayed as instructions to the various HVAC equipment components to make adjustments and the system could be re-simulated to test the effect of the changes and repeated until the desired effect was achieved. With such a system, it may not be necessary to have personnel take measurements and make manual adjustments to any of the equipment to effect desired changes. As buildings get more complicated and have more sophisticated components, they will become harder to managed, but if all of the components and attributes of the building are input to the CAD 306 when the building is designed, constructed and updated, it is possible to know exactly where all the components of the building are located within the walls, floors, basements, attics and rooftops, where all of the wiring, pipes, ducts, etc., are located within walls, how everything is controlled, etc., and thereby simply the overall maintenance of the building and improve the efficiency of its operation.

In another example, the representation/context may be a 2-D model, a 3-D model, a virtual tour, a component system model within the CAD 306, and may utilize a plurality of objects associated with the various components, items, building elements, geographical factors, time data, specifications and the like all associated with BIM 614. Particular information regarding each object may be in layers and or file structures and that data may or may not be represented based on the context selected for viewing the representation.

It is understood that not every HVAC system will contain every component noted above and that there may be additional components, systems, elements, items and the like in one or more HVAC systems. Further, the process indicated above may be configured for other systems, like power management system, water systems, waste systems, sprinkler systems, alarm systems and the like.

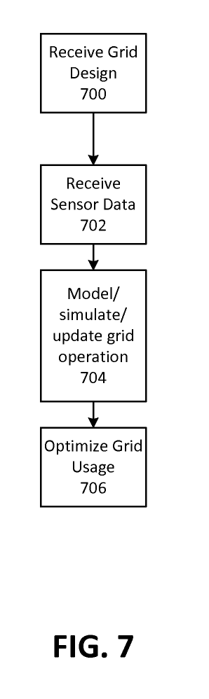

In one embodiment, illustrated in FIG. 7, a smart power grid may be designed and managed, where all components, geographic factors, structural/building elements and the like may be included. In one embodiment, grid design 700 may comprise wires, generators, poles, towers, sensors, monitors, cameras, substations, step up and step down stations, transformers, connections, sources, drains, environmental factors such as weather, wind, motion of the wires, distances, transfer stations, relays, inputs, cables, conduits, external radiation, fields, neighborhoods and the like. Each component, geographic factors, structural/building elements and the like included in a design 700 may include smart objects. The smart objects may be associated with one or more attributes. The objects and the attributes may be included and associated based on commercially available products, specifications, requirements, user interfaces, libraries, databases and the like.

In one embodiment, output requirements, profiles and the like may be associated with specifications for a power grid. Sensors 702 may provide real time or near real time data. Similar to the HVAC system noted above, the sensor data may be information system management, which may comprise each of the elements noted above with respect to BIM/CAD. Further, note that each element, object and attribute may comprise system information for use with system information management in the management of a power grid or any other type of system.

At 704, grid usage may be optimized. In one embodiment, sensors may detect a short, or a decrease in usage, or there may be historical information contained in system information management that implies and upcoming decrease in the power requirements. In response to determining an updated set of circumstances associated with one or more portions of a power grid based on either sensor data, user input, or other information, the circumstances of the update may be received by system information management. Accordingly, system information management may be configured to model and display the current state of the grid and may also be configured to manage various systems to meet specifications or requirements, or otherwise optimize a smart grid.

System information management may also be configured to send instructions to one or more of the components of a smart grid at 706, including but not limited to generators, stations, sub stations, transformers, sources, drains, step up stations, step down stations and the like to implement actions.

Accordingly, the design can be relied upon to influence the efficiency of the final systems and the final system can be optimized by updating the design and incorporating the design with real time or near real time data for optimization and management. In another example, the attribute data associated with each of the components, which make the components intelligent objects, can be used to aid in the design and construction of higher voltage systems, such as a high power grid, or the design and construction of the electrical system for a house, building, car, plane, etc. A designer may input information about different components and their location within a geographic area, such as a neighborhood, a town, a city, etc., or within a car, plane, train, etc., and instruct the CAD 306 to begin to tie the components together to connect them to a main power source, a control panel, a processor and other type of controller function. The CAD 306 could use the attribute data and intelligent programming designed into the CAD 306 to then determine how best to connect the components, wire types and qualities, and to design all of the intermediate components, insulators, transformers, boosters, sensors, etc., that might be needed to make the system work according to specifications, including physics, municipal codes, FAA requirements, FTC requirements, etc. In this manner, the CAD 306 could undertake much of the design effort and the design could be perfected by the efficiency of the intelligent design.

As used herein, the term “mobile device” or “wireless device” refers to a device that may from time to time have a position that changes. Such changes in position may comprise changes to direction, distance, and/or orientation. In particular examples, a mobile or wireless device may comprise a cellular telephone, wireless communication device, user equipment, laptop computer, other personal communication system (“PCS”) device, personal digital assistant (“PDA”), personal audio device (“PAD”), portable navigational device, or other portable communication devices. A mobile or wireless device may also comprise a processor or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” and/or “for example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed. While the present disclosure illustrates and describes a preferred embodiment and several alternatives, it is to be understood that the techniques described herein can have a multitude of additional uses and applications. Accordingly, the invention should not be limited to just the particular description and various drawing figures contained in this specification that merely illustrate various embodiments and application of the principles of such embodiments.

What is claimed:

1. A method of managing the design, construction and maintenance of a building, the method comprising:
receiving specifications data;
receiving structural data, the structural data comprising one or more structural elements, each structural element being associated with structural object data;
receiving component data, the component data comprising one or more components, each component being associated with component object data;
configuring for display, in a first context, the specifications data, a first portion of the structural object data, and a first portion of the component object data, for use during design and construction of the building;
receiving geographic data, the geographic data comprising one or more geographic elements, each geographic element being associated with geographic object data; and
configuring for display, in a second context, a second portion of the structural object data, a second portion of the component object data and the geographic object data, for use during maintenance of the building.

2. The method of claim 1 wherein each of the structural object data, the component object data, and the geographic object data are persistent objects.

3. The method of claim 1 further comprising receiving sensor data from one or more sensors data, and wherein said configuring for display, in a second context, includes using the sensor data during maintenance of the building.

4. The method of claim 3 wherein the one or more sensors data is real time data.

5. The method of claim 4 further comprising sending an instruction to one or more components based on the second context.

6. The method of claim 1 wherein the first context comprises one or more of a 2-D modeling context, a 3-D modeling context, a simulation context, a virtual tour context, a verification context, a commissioning context, a building context, and/or a optimizing context.

7. The method of claim 1 further comprising monitoring display of the second context to identify one or more components needing attention and to account for geographic data.

8. A computer readable storage medium having stored thereon processor executable instructions, the instructions comprising instructions to:
receive specifications data;
receive structural data, the structural data comprising one or more structural elements, each structural element being associated with structural object data;
receive component data, the component data comprising one or more components, each component being associated with component object data;
configure for display, in a first context, the specifications data, a first portion of the structural object data, and a first portion of the component object data, for use during design and construction of a building associated with the specifications data, the structural object data, and the component object data;
receive geographic data, the geographic data comprising one or more geographic elements, each geographic element being associated with geographic object data; and
configure for display, in a second context, a second portion of the structural object data, a second portion of the component object data and the geographic object data, for use during maintenance of the building.

9. The computer readable storage medium of claim 8 wherein each of the structural object data, the component object data, and the geographic object data are persistent objects.

10. The computer readable storage medium of claim 8 further comprising instructions to receive sensor data from one or more sensors, and wherein said instructions to configure for display, in a second context, includes instructions to use the sensor data during maintenance of the building.

11. The computer readable storage medium of claim 10 wherein the sensor data is real time data.

12. The computer readable storage medium of claim 11 further comprising instructions to send a request to one or more components based on the second context.

13. The computer readable storage medium of claim 8 further comprising instructions to monitor display of the second context to identify one or more components needing attention and to account for geographic data.

14. A system for the design, construction and management of a building, the system comprising:
a processor;
a memory couple to the processor, the memory having stored thereon instructions that when executed by the processor, cause the processor to:
receive specifications data;
receive structural data, the structural data comprising one or more structural elements, each structural element being associated with structural object data;
receive component data, the component data comprising one or more components, each component being associated with component object data;
configure for display, in a first context, the specifications data, a first portion of the structural object data, and a first portion of the component object data, for use during design and construction of a building associated with the specifications data, the structural object data, and the component object data;
receive geographic data, the geographic data comprising one or more geographic elements, each geographic element being associated with geographic object data; and
configure for display, in a second context, a second portion of the structural object data, a second portion of the component object data and the geographic object data, for use during maintenance of the building.

15. The system of claim 14 wherein each of the structural object data, the component object data, and the geographic object data are persistent objects.

16. The system of claim 14 further comprising instructions to receive sensor data from one or more sensors, and wherein said instructions to configure for display, in a second context, includes instructions to use the sensor data during maintenance of the building.

17. The system of claim 16 wherein the sensor data is real time data.

18. The system of claim 17 further comprising instructions to send a request to one or more components based on the second context.

19. The system of claim 14 further comprising instructions to monitor display of the second context to identify one or more components needing attention and to account for geographic data.
